(19) United States
(12) Patent Application Publication
(10) Pub. No.: US 2011/0141061 A1
(43) Pub. Date: Jun. 16, 2011

(54) TOUCH PANEL SYSTEM

(75) Inventor: Kee Wan LEE, Seoul (KR)

(73) Assignee: NURIBOM, Seoul (KR)

(21) Appl. No.: 12/961,822

(22) Filed: Dec. 7, 2010

(30) Foreign Application Priority Data
Dec. 14, 2009 (KR) 10-2009-0124115

(51) Int. Cl. G06F 3/042

(52) U.S. Cl. 345/175

(57) ABSTRACT

Provided is a touch panel system. The touch panel system includes: a light emitting module disposed on a portion other than the same plane as a screen structure and emitting light on a screen recognizing surface; and a image pickup module sensing a touch signal of the screen structure, wherein the system further includes a reflective module having at least one reflective mirror to allow the emitted by the light emitting module to be emitted onto the screen recognizing surface of the screen structure. Therefore, it is possible to implement a system of a thinner touch panel while maintaining a touch recognizing efficiency. Further, it is possible to efficiently recognize positions of two or more multi touch objects which are simultaneously inputted.

### CROSS-REFERENCE TO RELATED APPLICATIONS

This application claims priority under 35 U.S.C. §119 to Korean Patent Application No. 10-2009-0124115, filed on Dec. 14, 2009, in the Korean Intellectual Property Office, the disclosure of which is incorporated herein by reference in its entirety.

### TECHNICAL FIELD

The present invention relates to a touch panel system recognizing a touch signal of an external object through an image pickup unit.

### BACKGROUND

A touch panel, as a device transferring a user's command to a computer or a display device, replaces the function of a mouse with an object such as a finger or a pen. The touch panel is disposed in front of a screen of an LCD, a PDP, a projector, or the like so as to be easily manipulated by a user. The touch panel is used of a mobile phone and a blackboard and a bulletin board in a classroom, which are called an input type interactive white board, etc.

The touch panel includes various types such as a thin film resistor type, an electrostatic capacity type, an infrared matrix type, an infrared digital video camera type (hereinafter, referred to as a “camera”), etc., and the infrared matrix type or the infrared camera type is generally used for a screen having a size of 20 inches or more.

In the touch panel of the camera type, cameras are installed on edges of the outline of the touch panel and an infrared background is disposed on the outline of a touch panel frame facing the cameras. Accordingly, when a touch object touches an inner region of the touch panel frame, the touch object interrupts the infrared background and the camera captures it, whereby the touch panel determines the touch or not and touch locations. Each of the parts is installed on a glass plate having high transmittance and a glass plate assembly is installed in front of the display screen to correspond to the display screen.

Referring to FIGS. 1A, 1B, and 1C, a schematic configuration and a problem of the touch panel system in the related art will be described.

The touch panel system in the related art includes a screen structure 10 to be touched by an external object T, a light emitting module 20 supplying light onto the surface of the screen structure 10, and an image pickup unit P sensing the external object T's touching the screen structure 10.

FIG. 1B is a schematic perspective conceptual diagram of the touch panel system of FIG. 1A viewed from the top and FIG. 1C is a schematic perspective conceptual diagram of the touch panel system of FIG. 1A viewed from the front.

The touch panel system in the related art includes a light emitting module 20 formed on a lateral surface of the entire screen structure 10. Further, an LED 21 that is inserted into the light emitting module 20 to emit a light source is disposed and light emitted from the LED 21 is scattered through a scattering plate 22 onto a front surface and supplied onto a recognizing surface 11 which is a front surface of the screen structure.

However, in the touch panel system in the related art, the recognizing surface becomes thick due to the sizes of the image pickup unit P and the light emitting module 20 and an area h of a sensor exposed to the outside becomes wider. In particular, in the light emitting module using the LED 21 as a point light source, a distance w between the scattering plate 22 of the light and the point light source should be widened in order to widen a distance d between the point light sources and maintain a uniform quantity of light, as a result, the size of an entire configuration increases. A distance between light emitting bodies is decreased in order to decrease the distance w. For this, the number of the LED should be remarkedly increased, causing various problems such as a cost and a thermal efficiency.

Further, as shown in FIG. 1A, in the system having two image pickup units P, since a position cannot be accurately calculated in a surrounding zone (dead zone D) of a straight line crossing the two image pickup units, an error of recognition frequently occurs. Also, an incidence angle of a light emitting surface that is disposed in a diagonal direction of the image pickup unit P is largely influenced by a length-and-width ratio. Accordingly, as the length-and-width ratio is increased, the incidence angle θ is decreased as much, such that the quantity of light is reduced and the recognizing rate is very lowed.

Moreover, when a plurality of objects touches the recognizing surface of the screen structure, it is difficult to determine positions of two or more multi-touch objects which are simultaneously inputted.

### SUMMARY

An exemplary embodiment of the present invention provides a touch panel system including: a light emitting module disposed on a portion other than the same plane as a screen structure and emitting light on a screen recognizing surface; a image pickup module sensing a touch signal of the screen structure; and a reflective module having at least one or more reflective mirror so that light emitted through the light emitting module is emitted on the screen recognizing surface of the screen structure.

In addition, the touch panel system may include a light emitting module disposed on a portion other than the same plane as a screen structure and a reflective module having at least one or more reflective mirror so that light emitted through the light emitting module is guided to the screen recognizing surface.

The reflective module includes a first reflective mirror disposed on the same plane as the recognizing surface of the screen structure and a light source emitted through the light emitting module is emitted on the recognizing surface of the screen structure through the first reflective mirror.

The reflective module includes a first reflective mirror disposed on the same plane as the recognizing surface of the screen structure; and a second reflective mirror reflecting a light source emitted from the light emitting module that is disposed on a rear surface of the screen structure to the first reflective mirror.

Further, in another exemplary embodiment, the reflective module includes a first reflective mirror disposed on the same plane as the recognizing surface of the screen structure; and second and third mirrors guiding a light source of the light emitting module disposed on a lateral surface of the screen structure to the screen recognizing surface.

Further, unlike the embodiment according to the present invention described above, the light emitting module may include at least two or more reflective mirrors disposed on a lateral surface of the screen structure so that the light emitted from the light emitting module penetrate the screen structure and the penetrated light is guided to the screen recognizing surface. In particular, in this case, the screen structure may be made of a transparent material and the reflective mirror may further include a first mirror disposed on the same plane as the recognizing surface of the screen structure; a fourth mirror reflecting the light to the first mirror and disposed on the same plane as the screen structure.

The touch panel system may have a different layout of the image pickup module, except that the light emitting module is disposed on a rear surface or a lateral rear surface.

In detail, the image pickup module may include two camera modules and the camera modules may be disposed on the same plane as the screen structure.

In particular, the image pickup module may pick up the recognizing surface of the screen structure through at least one or more reflective mirror.

Moreover, another exemplary embodiment of the present invention provides a touch panel system including: two or more light emitting modules emitting light on a recognizing surface of a screen structure; a image pickup module sensing a touch signal of the screen structure; wherein a reflective surface is formed in a pickup direction of the image pickup module. Particularly, the image pickup module may include a camera unit, the light emitting module may include two light emitting modules in a direction adjacent to the camera unit, or the image pickup module may include two camera units, the light emitting module may include three light emitting modules in a direction adjacent to the camera unit.

Other features and aspects will be apparent from the following detailed description, the drawings, and the claims.

### BRIEF DESCRIPTION OF THE DRAWINGS

FIG. 1A is a schematic diagram of a touch panel system in the related art;

FIG. 1B is a schematic perspective conceptual diagram of the touch panel system of FIG. 1A viewed from the top;

FIG. 1C is a schematic perspective conceptual diagram of the touch panel system of FIG. 1A viewed from the front;

FIGS. 2A to 2D are schematic conceptual diagrams of main parts showing an exemplary embodiment of a touch panel system according to the present invention;

FIGS. 3A and 3B are layout conceptual diagrams of an image pickup unit in the related art;

FIGS. 4A and 4B are layout implementing conceptual diagrams of an image pickup unit according to an exemplary embodiment of the present invention;

FIGS. 5A and 5B are layout implementing conceptual diagrams of an image pickup unit according to another exemplary embodiment of the present invention;

FIG. 6 is a reference diagram for describing a problem of recognition in multi-touching in the related art; and

FIGS. 7A and 7B are configuration diagrams for recognizing multi-touching according to an exemplary embodiment of the present invention.

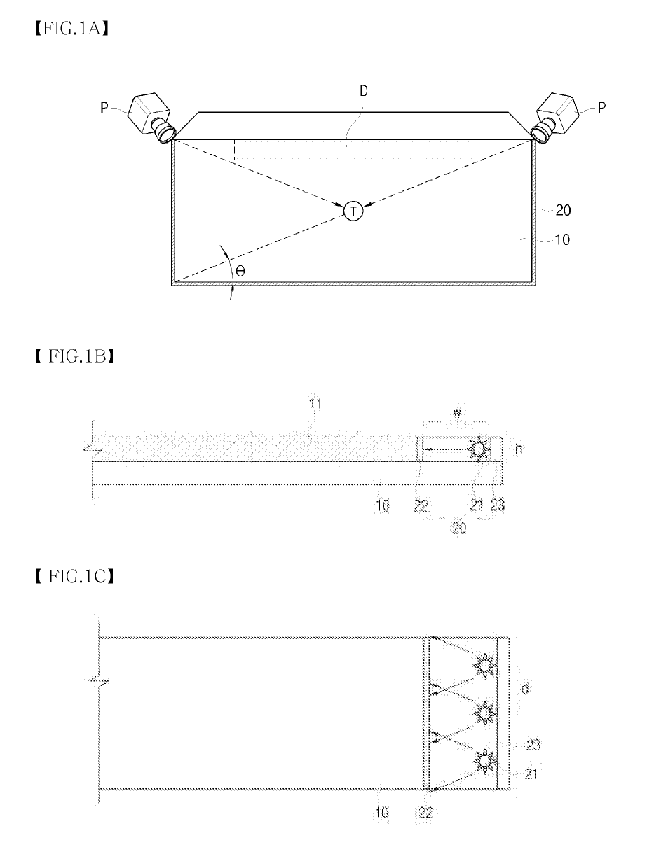

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

According to the present invention, a light emitting module and an image pickup module constituting a touch panel system are disposed on a position other than the same plane as a screen structure to decrease the thickness of an entire system structure and increase a recognizing efficiency in a touch panel.

A touch panel system according to the exemplary embodiment of the present invention generally includes: a light emitting module disposed on a position other than the same plane as a screen structure and emitting light onto a screen recognizing surface; and an image pickup module sensing a touch signal of the screen structure and further includes a reflective module allowing the light emitted by the light emitting module to be emitted onto the screen recognizing surface of the screen structure. That is, the system may include the light emitting module disposed on the position other than the same plane as the screen structure and the reflective module having at least one reflective mirror guiding the emitted by the light emitting module to the screen recognizing surface.

Hereinafter, features of the present invention will be described through exemplary embodiments of the present invention.

### 1. First Exemplary Embodiment

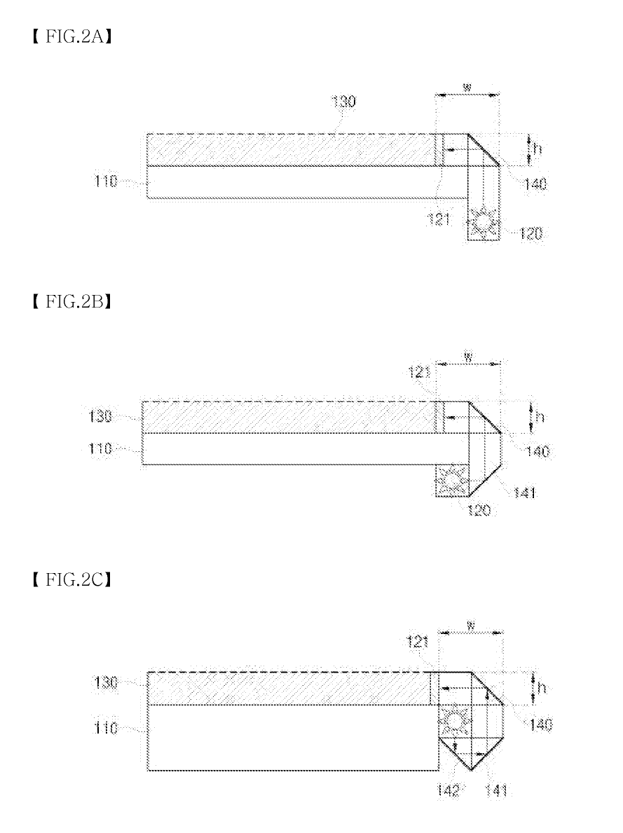

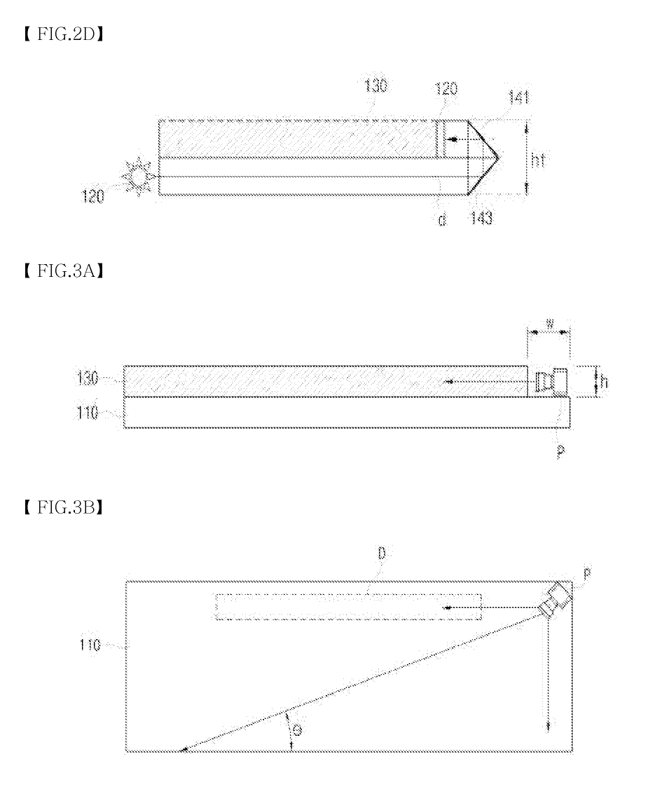

As shown in FIG. 2A, the touch panel system according to the present invention include a light emitting module 120 disposed on a position other than the same plane as a screen structure 110 and a reflective module having at least one reflective mirror 140 guiding the light emitted by the light emitting module 120 to a recognizing surface 130 of the screen structure 110.

In particular, the touch panel system includes a first reflective mirror 140 disposed on the same plane as the recognizing surface 130 of the screen structure 110, wherein the light emitted from the light emitting module 120 is guided to the recognizing surface 130 of the screen structure through the first reflective mirror 140. Accordingly, it is possible to arbitrarily decrease the height h of the recognizing surface and sufficiently ensure the width w of the light emitting module which is a problem in the related art. In the related art, since light is supplied onto the recognizing surface of the screen structure and the image pickup module sensing the light is disposed on the same plane as the screen structure, various technical limits and a problem that the thickness of the entire system structure becomes thicker in order to implement it. However, in the present invention, since the light emitting module is disposed on a different plane (that is, it includes the lateral rear surface or the bottom of the screen structure) other than the same plane as the screen structure by using the reflective module, it is possible to implement a free design and improve a recognizing.

As described above, since the present invention includes the light emitting module or the image pickup module disposed on the position other than the same plane as the screen structure, it is possible to change the number of the reflective modules and change the position of the light emitting module to be implemented therethrough.

### 2. Second Exemplary Embodiment

In the above-mentioned first exemplary embodiment, a configuration in which the light emitting module is disposed on the lateral rear surface of the screen structure is shown as an example, but in the modified exemplary embodiment, the light emitting module may be closely attached to the bottom of the screen structure 110.

That is, as shown in FIG. 2B, since the light emitting module 120 is disposed on the bottom of the screen structure 110 unlike the first exemplary embodiment and a path of light emitted through the light emitting module 120 is changed to two reflective modules, that is, a first reflective mirror 140 and a second reflective mirror 141, it is possible to guide the emitted light to the screen recognizing surface of the screen structure. Also, the light emitting module is disposed on a different plane from the screen structure to decrease the thickness of the entire system and the entire system is not upsized while sufficiently ensuring the height h of the recognizing surface and a distance w between a scattering plate 121 and the light emitting module 120.

### 3. Third Exemplary Embodiment

FIG. 2C shows an implemented example having three reflective modules according to the present invention. As shown in FIG. 2C, the light emitted from the light emitting module is reflected through a third reflective mirror 142, the second reflective mirror 141, and the first reflective mirror 140 and guided to the recognizing surface 130 through the scattering plate 121.

Also, in the exemplary embodiment like the above-described embodiment, it is possible to reduce the thickness of the entire system and the entire system is not upsized while sufficiently ensuring the height h of the recognizing surface and the distance w between the scattering plate 121 and the light emitting module 120.

### 4. Fourth Exemplary Embodiment

Referring to FIG. 2D, an exemplary embodiment different from the above-mentioned exemplary embodiments will be described.

The modified exemplary embodiment includes the light emitting module 120 passing through the screen structure 110 and incident light passing through the screen structure is guided to the recognizing surface 130 through a fourth reflective mirror 143 and the first reflective mirror 141. The exemplary embodiment may use two reflective mirrors.

In particular, the screen structure may be formed a transparent material in order to implement the configuration of the present invention. Particularly, in this case, since the fourth reflective mirror 143 is disposed on the same plane as the screen structure, it is possible to implement the thickness w between the scattering plate and the light emitting module and the thin thickness ht of the entire system.

### 5. Fifth Exemplary Embodiment

Hereinafter, another modified exemplary embodiment according to the present invention will be described.

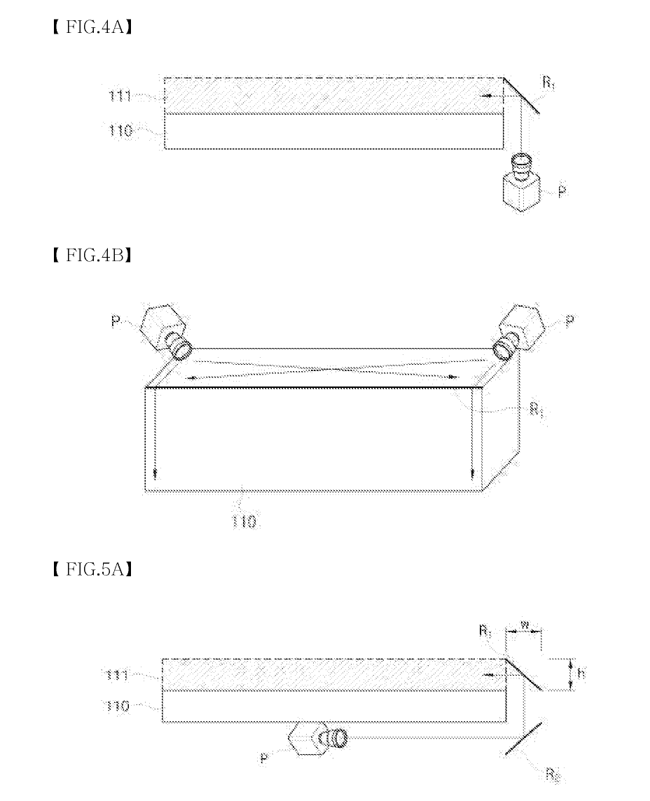

FIGS. 3A and 3B are layout conceptual diagrams of an image pickup unit according to the related art. As shown in FIG. 3A, in the entire system including the screen structure 110 and the recognizing surface 130 thereof, the image pickup unit P is disposed on the same plane as the recognizing surface 130 of the screen structure 110. Accordingly, the size h of the entire recognizing surface and the thickness w of the entire module unit configuring the image pickup unit is limited to reduce due to the size of the image pickup unit P.

As shown in FIG. 3B, a dead zone D having many calculation errors is upsized in proportion to the size of the screen. Particularly, as a length-and-width ratio is increased in the screen, an incidence angle θ of the light emitting surface is decreased, such that the quantity of light is insufficient.

FIGS. 4A and 4B are layout implementing conceptual diagrams of an image pickup unit according to an exemplary embodiment of the present invention.

The size h of the recognizing surface and the thickness w of the entire module unit configuring the image pickup module may be arbitrarily reduced by using a reflective module R1. In detail, as shown in FIG. 4A, the image pickup module P is disposed on a different plane from the screen structure. That is, in the exemplary embodiment, the image pickup module may be implemented by using the reflective module.

In particular, referring to FIG. 4B, two image pickup modules P have a reflective mirror R1 of the same size as the entire screen structure and may be disposed behind an original position. In this case, the dead zone formed by the image pickup modules facing each other is significantly reduced.

FIGS. 5A and 5B are layout implementing conceptual diagrams of an image pickup unit according to another exemplary embodiment of the present invention.

As shown in FIG. 5A, when the image pickup unit P is disposed on the bottom of the screen structure 110, the image pickup unit may have two reflective mirrors R1 and R2. The arrangement of the reflective mirrors is variously changed depending on the arrangement of the image pickup unit P like the first to fourth exemplary embodiments. As shown in FIG. 5B, when two image pickup units P are disposed on the bottom of the screen structure 110, the recognizing surface of the screen structure may be picked up through two reflective mirrors. Accordingly, it is possible to pick up the entire recognizing surface through each of paths , , , and between the reflective mirrors R1 and R2 and prevent the incidence angle from being excessively decreased.

### 6. Sixth Exemplary Embodiment

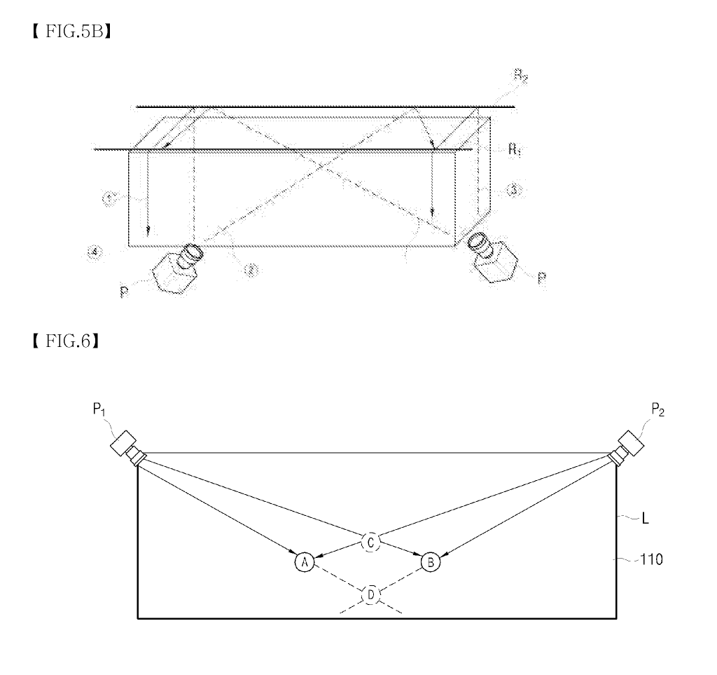

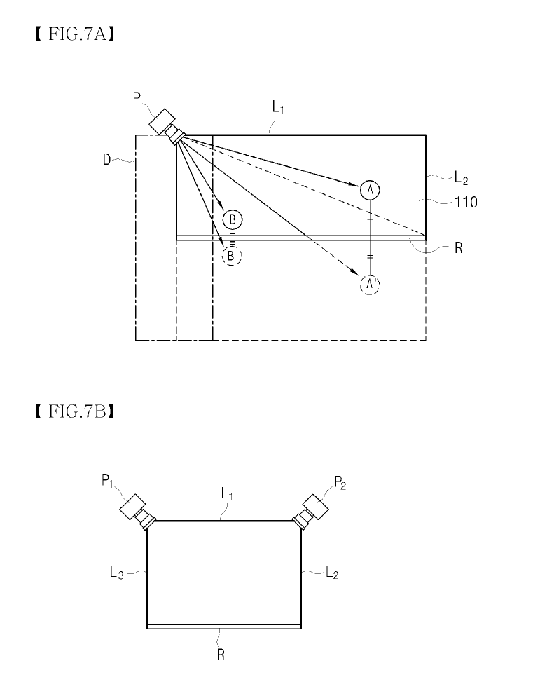

FIG. 6 is a reference diagram for describing a problem of recognition in multi-touching in the related art and FIGS. 7A and 7B are configuration diagrams for recognizing multi touching according to an exemplary embodiment of the present invention.

FIG. 6 is a conceptual diagram for describing an error of recognition when a plurality of multi touch objects is disposed on the screen structure 110 in the related art. It is assumed that a light emitting module L is provided on three target surfaces.

When the touched objects A and B are disposed in two image pickup modules P1 and P2 and picked up, in the case where two or more objects are recognized in the image pickup module, it is difficult to accurately determine whether the objects A and B that actually exist or the objects are disposed at positions C and D on the same line.

In the exemplary embodiment, as shown in FIG. 7, since the reflective module is disposed on one image pickup module in order to solve the problem, it is possible to sense accurate positions of the multi touch objects.

In detail, as shown in FIG. 7A, the system includes target surfaces L1 and L2 including one image pickup module P and two light emitting modules and one reflective module R. In particular, the reflective module R is disposed in a pick-up direction of the image pickup module P and the target surfaces L1 and L2 including the light emitting modules have the target surface L1 adjacent to the image pickup module and the target surface L2 adjacent to the target surface L1. A region D is a region where an error of recognition occurs as shown in FIG. 7A.

In the structure shown in the figure, when two target objects A and B are multi-touched, images A′ and B′ of the objects that are positioned at a distance corresponding to the objects A and B and mirrored on the reflective module R are recognized by the image pickup module P and positions of the objects can be accurately determined by calculating points corresponding to the images A′ and B′. Accordingly, the actual objects A and B and the reflective objects A′ and B′ formed on the reflective surface implemented by the reflective module are positioned accurately at symmetric positions to each other regardless of an observer' position. That is, when a distance between the actual object and the reflective object is recognized as a symmetric overlapped distance by the image pickup module, it is possible to estimate the positions of the target objects.

Besides the above-described structure, as shown in FIG. 7B, the system may include two image pickup modules P1 and P2, and three target recognizing surfaces L1, L2, and L3 including the light emitting modules and is modified to a structure in which the reflective module R is formed on an opposite surface which is not adjacent to the camera as the image pickup module. In addition, the actual objects A and B and the reflective objects A′ and B′ formed on the reflective surface of the reflective module are recognized by the same method as the method described in FIG. 4B.

According to exemplary embodiments of the present invention, it is possible to implement a touch panel system that is thinner while maintaining a touch recognizing efficiency. Further, in the touch panel system according to the present invention, it is possible to efficiently recognize positions of two or more multi touch objects that are simultaneously inputted.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A touch panel system, comprising:
a light emitting module disposed on a position other than the same plane as a screen structure and emitting light on a recognizing surface; and
an image pickup module sensing a touch signal of the screen structure,
wherein the system further includes a reflective module having at least one reflective mirror to allow the light emitted by the light emitting module to be emitted onto the recognizing surface of the screen structure.

2. The system of claim 1, wherein the reflective module includes a first reflective mirror disposed on the same plane as the recognizing surface of the screen structure and a light emitted from the light emitting module is emitted onto the recognizing surface of the screen structure through the first reflective mirror.

3. The system of claim 1, wherein the reflective module includes:
a first reflective mirror disposed on the same plane as the recognizing surface of the screen structure; and
a second reflective mirror reflecting the light emitted from the light emitting module that is disposed on the bottom of the screen structure to the first reflective mirror.

4. The system of claim 1, wherein the reflective module includes:
a first reflective mirror disposed on the same plane as the recognizing surface of the screen structure; and
second and third mirrors guiding the light emitted from the light emitting module disposed on the lateral surface of the screen structure to the screen recognizing surface.

5. The system of claim 1, wherein the light emitting module includes at least two reflective mirrors disposed on the lateral surface of the screen structure so that the light emitted from the light emitting module penetrate the screen structure and the penetrated light is guided to the screen recognizing surface.

6. The system of claim 5, wherein the reflective mirror includes:
a first mirror disposed on the same plane as the recognizing surface of the screen structure; and
a fourth mirror reflecting the light to the first mirror and disposed on the same plane as the screen structure.

7. A system of touch panel, comprising:
a light emitting module emitting light onto a recognizing surface of a screen structure; and
an image pickup module sensing a touch signal of the screen structure,
wherein the image pickup module includes two camera modules and the camera modules are disposed at positions other than the same plane of the screen structure and pick up the recognizing surface of the screen structure through at least one reflective mirror.

8. A system of touch panel, comprising:
two or more light emitting modules emitting light on a recognizing surface of a screen structure; and
an image pickup module sensing a touch signal of the screen structure,
wherein a reflective surface is formed in a pickup direction of the image pickup module.

9. The system of claim 8, wherein the image pickup module includes one camera unit and the light emitting module includes two light emitting modules in a direction adjacent to the camera unit.

10. The system of claim 9, wherein the image pickup module includes two camera units and the light emitting module includes three light emitting modules in a direction adjacent to the camera unit.
